(19) United States
(12) Patent Application Publication
(10) Pub. No.: US 2008/0239363 A1
(43) Pub. Date: Oct. 2, 2008

(54) COPIER DEVICE CAPABLE OF ELECTRONICALLY STORING AND RECALLING COPIED DOCUMENTS

(75) Inventor: Wei Ming, Cupertino, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/691,656

(22) Filed: Mar. 27, 2007

(51) Int. Cl. H04N 1/00

(52) U.S. Cl. 358/1.15

(57) ABSTRACT

A method is described for electronically storing images of previously copied documents and recalling them for reprinting later. When a user uses a copier to make a physical copy of a physical document, the document image is stored by the copier, and certain document management information is captured and stored in a document management database to facilitate later recall and reprint of the document images. A document management section, which resides either on the copier or on a server connected to the copier by a network, performs document management functions that allow a user to select a previously copied and stored document for reprinting.

### BACKGROUND OF THE INVENTION

1. Field of the Invention

This invention relates to a copier device, and in particular, it relates to a copier device that can electronically store copied documents and recall them for reprinting later.

2. Description of Related Art

Conventional copier devices produce physical copies of a physical document but do not store any information regarding the content of the documents being copied that can be used later by a user to make additional physical copies of the same document. In other words, copy is a one-time transaction. Many copier devices today produce physical copies of a document by first scanning it to generate digital image data representing an image of the document, and then printing a physical copy of the document from the digital image data. Such copier devices have a scanning section and a printing section. In addition, a copier is often provided as a part of a multifunction device (sometimes referred to as a MFP or AIO (all-in-one device)), which is a device that combines copy, scan (i.e. generating a digital file from the physical document but does not generate a physical copy), and print (i.e. producing a physical copy of a document from digital data) functions in a single device. The digital image generated by the scanning section during a copy action may temporarily exist on the copier, but it is not stored and made available to the user at a later time. Thus, copy function of a conventional copier or MFP remains a one-time transaction.

### SUMMARY

The present invention is directed to a copy method and copier device that substantially obviates one or more of the problems due to limitations and disadvantages of the related art.

An object of the present invention is to provide a copy method and copier device that store digital data representing content of the copied document and allow a user to recall the digital data to produce additional physical copies of the document at a later time.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a data processing system including a copier, which include: (a) making a physical copy of a physical document using the copier by scanning the physical document to generate digital image data representing the document and printing the physical copy from the digital image data; (b) storing the digital image data representing the document in a storage device; (c) generating document management information associated with the digital image data representing the document; and (d) storing the document management information in a document management database. The method may further includes: (e) displaying document management information to a user; (f) receiving a user input selecting one or more documents; (g) in response to the user input, retrieving stored digital image data representing the selected document; and (h) printing the retrieved digital image data.

In another aspect, the present invention provides a copier which includes: a scanning section for generating digital image data representing documents by scanning a physical medium; a printing section for forming images on a physical medium from digital image data; a storage device; a user interface section for communicating with a user; and a management section for storing in the storage device digital image data representing documents generated by the scanning section during a copy function, generating document management information associated with documents represented by the digital image data, storing the document management information in a document management database, displaying stored document management information to a user using the user interface, receiving a user input indicating one or more selected documents, and retrieving from the storage device stored digital image data representing the selected documents.

In yet another aspect, the present invention provides a data processing system which includes: a copier connected to a network including a scanning section for generating digital image data representing a document by scanning a physical medium, a printing section for forming images on a physical medium from digital image data, a user interface section for communicating with a user, and a control section for determining whether a copy function or a recall function is to be performed; a storage device connected to the network; and a server connected to the network, the server including a management section, wherein the control section of the copier transmits a first request to the server if it determines that a copy function is to be performed and transmits a second request to the server if it determines that a recall function is to be performed, wherein in response to the first request, the management section of the server stores in the storage device digital image data representing documents generated by the scanning section during the copy function, generates document management information associated with documents represented by the digital image data, and stores the document management information in a document management database, and wherein in response to the second request, the management section of the server transmits stored document management information to the copier to be displayed to a user, and retrieves stored digital image data from the storage device based on a user selection of one or more documents.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a method for storing and recalling previously copied documents according to an embodiment of the present invention.

FIG. 2 illustrates a copier or MFP in which methods for storing and recalling previously copied documents according to an embodiment of the present invention may be implemented.

### DETAILED DESCRIPTION OF PREFERRED EMBODIMENTS

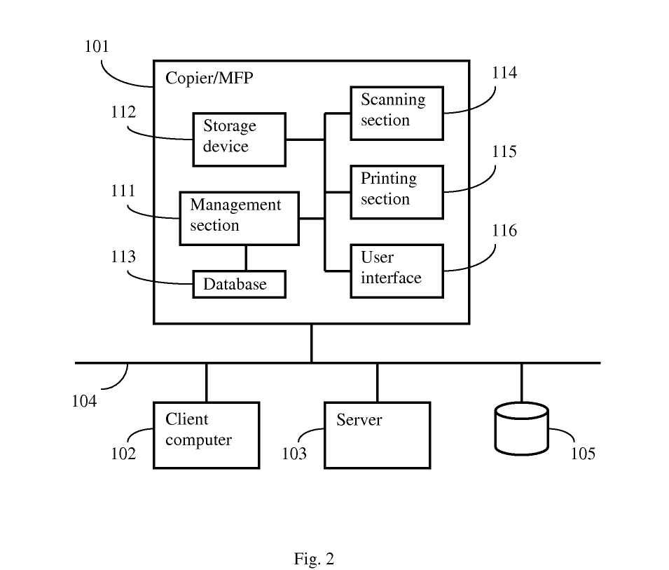

Embodiments of the present invention provide a method for electronically storing images of previously copied documents and recalling them for reprinting later. When a user uses a copier to make a physical copy of a physical document, the document image is stored by the copier, and certain document management information is captured and stored in a document management database to facilitate later recall and reprint of the document images. FIG. 2 schematically illustrates a data processing system in which the image storage and recall method according to embodiments of the present invention is implemented. The data processing system includes an image reproduction device 101, which may be a copier, a multifunction device (sometimes referred to as MFP or AIO (all-in-one)) that combines copy, scan and print functions, or any other device that includes a copy function. For brevity, in this disclosure the term “copier” is used to refer to all such image reproduction devices and is used synonymously with image reproduction device unless the context indicates otherwise.

As shown in FIG. 2, the copier 101 may be optionally connected to one or more servers 103 and/or client computers 102 by a network 104. The copier 101 includes a scanning section 114 for generating digital image data by scanning a physical medium (e.g. paper) and a printing section 115 for forming images on a physical medium from digital image data. The scanning section 114 and the printing section 115 are components of a conventional copier, but in a conventional copier, the digital image data is discarded after the physical copy is made. In the copier 101, a storage device 112 is provided to store digital image data generated by the scanning section during a copy action. A management section 111 (implemented by hardware, software or firmware) manages the image storage and recall functions. The management section 111 maintains a document management database 113 that stores descriptive information regarding the images stored in the storage device 112. A user interface 116, such as a control panel including buttons, a display screen, a touch screen, a full keyboard, and/or other suitable mean is used for receiving input from a user and displaying information to the user. Although not shown, the copier 101 also includes other necessary memories, an I/O section, additional processing sections to perform image processing function (optional), or other components.

Although the storage device 112 is shown in FIG. 2 as a part of the copier 101, the digital image data may also be stored on a remote storage device 105 accessible to the copier via the network 104, or on a storage device (e.g. hard disk) of the client computer 102. In this case, the copier or the server preferably stores information regarding the client computer, such as user accounts and passwords associated with the client computer, its path, etc. Alternatively, some of the digital image data (e.g. more recent image data) may be stored in the local storage device 112 and some (e.g. older image data) may be stored on the network storage device 105 and/or the client computer 102. Further, although the management section 111 is shown in FIG. 2 as a part of the copier 101, some or all of its functionalities may reside on the server 103. The document management database 113 may also reside on the server 103. In the case the management section is located on the server, the management section communicate with the user via the copier. Locating the management section 111 and the document management database 113 on the server has many advantages, especially in an environment typically found in a large organization where multiple copiers/MFPs are connected together by a network. It provides flexibility when storing large volume of data and allows different copiers to share stored image data so that a user can reprint an image previously copied on another copier.

In a multi-user environment where each user is assigned a user ID to log in to the copier, it is preferable that images of previously copied documents are only available to the same user who made the copies. This protects the users' privacy. Public or shared folders may also be set up for a pre-registered user group, such that the documents in folder are available to users belonging to the group.

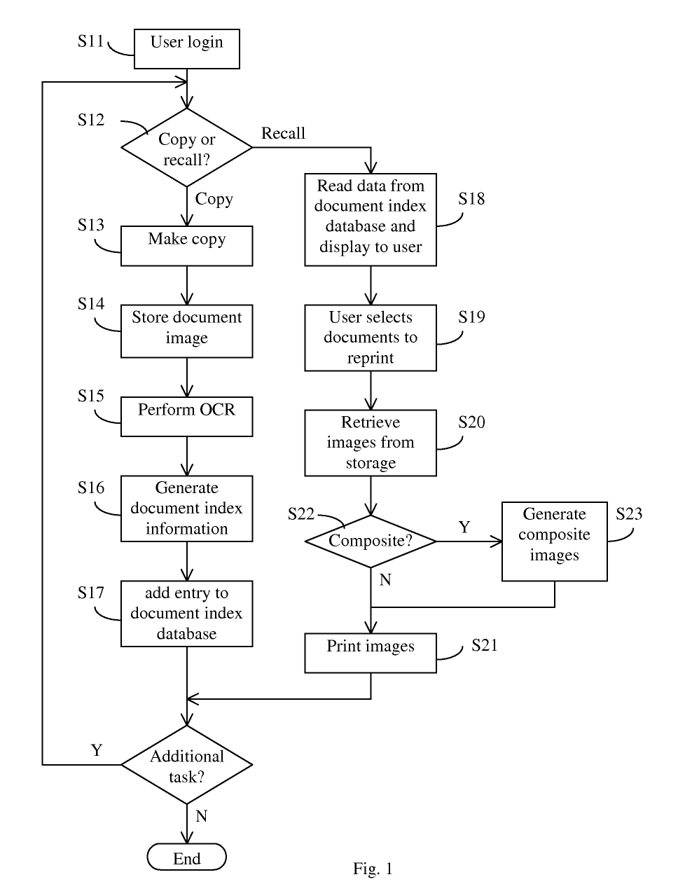

FIG. 1 illustrates a digital image storage and recall method according to an embodiment of the present invention. As shown in FIG. 1, after a user logs in to a copier (step S11), the user selects a “copy” function or a “recall” function (step S12). If a copy function is selected, the user supplies an original physical document, and the copier makes a physical copy of the original document (step S13). The scanning section 114 of the copier generates digital image data as a part of the copy process. The management section 111 of the copier stores the digital image data of the document in a storage device 112 (step S14). The management section (or a separate OCR section) performs an optical character recognition (OCR) procedure to capture textual content (if available) from the document image (step S15). Based on the captured textual content, the management section generates document management information associated with the document (step S16). The document management information may include one or more of the following: a title, a short description of the document such as “memorandum,” “meeting minute,” a reference code or control code, date of the document, etc. As an alternative to or in addition to OCR (step S15), the management section may request the user to manually enter document management information. In addition, if the login process requires the user to enter certain reference information for accounting purposes, such reference information may also be made a part of the document management information. The document management information preferably also includes the date and time when the copy is made, and the user ID of the user who made the copy if the copier is used in a multi-user environment. Step S16 encompasses all such various ways of generating document management information. The management section then adds an entry for the stored document in the document management database (step S17). Each entry in the document management database associates a stored document image with document management information.

In step S12, if the user selects a recall function, the management section retrieves document management information from the document management database and displays the information to the user via the user interface (step S118), and the user selects one or more documents to reprint (step S19). To assist the user in selecting stored document images for reprint, the management section may use various techniques to categorize the documents based on the document management information and displays document management information to the user in an organized manner. Multiple levels of categories may be used. A use or an administrator may program the management section to define desired categories of documents. A search capability may also be implemented in the management section to allow users to search for particular documents using various search criteria. For example, a search process may include receiving search criteria from the user, retrieving document management information according to the search criteria, and displaying the retrieved document management information to the user. As pointed out earlier, to protect user privacy in a multi-user environment, all document images are associated with a user ID, and each user normally can only recall document images belonging to that user. A user may also selectively share his images, i.e. allow other users to access images belonging to that user. The above document organization, searching and sharing methods are well known in the relevant art and may be implemented by those skilled in the art without undue experimentation. Depending on the display capability of the user interface section 116 of the copier, information may be displayed to the user in a variety of ways such as lists, trees, folders, thumbnails, full images, etc. The user uses the user interface section to review and change the displayed information, select a category, search for a document, select documents, etc. This interactive process is depicted in a simplified manner as steps S18 and S19 in FIG. 2.

After the user selects one or more documents to reprint, the copier retrieves image data of the selected documents from the storage device (step S20), and prints the retrieved images (step S21). Instead of printing the stored images as is, the user may choose to generate composite images from the stored image data (steps S22), in which case the copier generates the composite images by reducing the size of the original images and arranging multiple images on a page (step S23). Step S23 may be performed by a separate image processing section of the copier. After the selected documents are printed, if the user wishes to perform additional copy or recall tasks, steps S12 to S23 are repeated.

As stated earlier, the management section that performs various steps shown in FIG. 1 may be located either on the copier or on a networked server 103. In particular, steps S14 to S17 and S18 to S20 may be performed by a management section located on the server. In such a case, a control section in the copier performs step S12, i.e., determining whether a copy or recall task is to be performed based on a user instruction, and requests the server to perform either steps S14 to S17 (storing images) or steps S18 to S20 (recalling images) depending on the task.

Further, if the document management function is performed by the server, this function may be integrated with other document management functions already performed by the server. For example, a large organization may have existing a document management system handled by a server, and the document management method (i.e. steps S14 to S17 and S18 to S20) may be implemented as a part of the over document management system. In addition, the recall function may also be performed remotely from the copier, by using a client computer 102 connected to the network 104, and the recalled images may be directed to any copier, printer or multifunction device connected to the network for printing.

An advantage of embodiments of the present invention is that it makes it possible for a user to make additional copies of a previously copied document without the original. It also makes it easy to generate composite images from one or more previously copied documents. In addition, it allows copiers and copy function to be integrated into an organization's document management system.

It will be apparent to those skilled in the art that various modification and variations can be made in the method of the present invention without departing from the spirit or scope of the invention. Thus, it is intended that the present invention cover modifications and variations that come within the scope of the appended claims and their equivalents.

What is claimed is:

1. A method implemented in a data processing system including a copier, comprising:
(a) making a physical copy of a physical document using the copier by scanning the physical document to generate digital image data representing the document and printing the physical copy from the digital image data;
(b) storing the digital image data representing the document in a storage device;
(c) generating document management information associated with the digital image data representing the document; and
(d) storing the document management information in a document management database.

2. The method of claim 1, wherein the document management information includes one or more of a title, a short description, a date of the document, a date and time the copy was made, and a reference code.

3. The method of claim 1, further including:
prior to step (a), obtaining a user ID of a user operating the copier;
wherein the document management information includes the user ID.

4. The method of claim 1, wherein step (c) includes capturing textual content from the digital image data using optical character recognition.

5. The method of claim 1, wherein step (c) includes receiving document management information manually inputted by a user.

6. The method of claim 1, further comprising:
(e) displaying document management information to a user;
(f) receiving a user input selecting one or more documents;
(g) in response to the user input, retrieving stored digital image data representing the selected document; and
(h) printing the retrieved digital image data.

7. The method of claim 6, wherein step (h) includes generating composite images from the retrieved digital image data and printing the composite image data.

8. The method of claim 6, wherein step (e) includes categorizing the documents represented by the digital image data stored in the storage device based on the document management information and displaying the document management information according to the categorization.

9. The method of claim 6, wherein step (e) includes receiving search criteria from the user, retrieving document management information according to the search criteria, and displaying the retrieved document management information to the user.

10. The method of claim 6, further comprising:
receiving an instruction from the user of the copier indicating a copy function or a recall function;
wherein steps (a)-(d) are performed when the instruction indicates a copy function, and
wherein steps (e)-(h) are performed when the instruction indicates a recall function.

11. A copier comprising:
a scanning section for generating digital image data representing documents by scanning a physical medium;
a printing section for forming images on a physical medium from digital image data;
a storage device;
a user interface section for communicating with a user; and
a management section for storing in the storage device digital image data representing documents generated by the scanning section during a copy function, generating document management information associated with documents represented by the digital image data, storing the document management information in a document management database, displaying stored document management information to a user using the user interface, receiving a user input indicating one or more selected documents, and retrieving from the storage device stored digital image data representing the selected documents.

12. The copier of claim 11, wherein the management section captures textual content from the digital image data using optical character recognition for use as document management information.

13. The copier of claim 11, further comprising an image processing section for generating composite images from the retrieved digital image data.

14. A data processing system comprising:
a copier connected to a network including a scanning section for generating digital image data representing a document by scanning a physical medium, a printing section for forming images on a physical medium from digital image data, a user interface section for communicating with a user, and a control section for determining whether a copy function or a recall function is to be performed;
a storage device connected to the network; and
a server connected to the network, the server including a management section,
wherein the control section of the copier transmits a first request to the server if it determines that a copy function is to be performed and transmits a second request to the server if it determines that a recall function is to be performed,
wherein in response to the first request, the management section of the server stores in the storage device digital image data representing documents generated by the scanning section during the copy function, generates document management information associated with documents represented by the digital image data, and stores the document management information in a document management database, and
wherein in response to the second request, the management section of the server transmits stored document management information to the copier to be displayed to a user, and retrieves stored digital image data from the storage device based on a user selection of one or more documents.

15. The data processing system of claim 14, wherein the management section of the server captures textual content from the digital image data using optical character recognition for use as document management information.

16. The data processing system of claim 14, wherein the copier further comprises an image processing section for generating composite images from the retrieved digital image data.
